(19) United States
(12) Patent Application Publication
(10) Pub. No.: US 2006/0214919 A1
(43) Pub. Date: Sep. 28, 2006

(54) Multi-panel writing surface and visual display device

(76) Inventors: Greg Moore, Morgans Point, TX (US); John Hardt II, Belton, TX (US); Abbas Nasseri, Temple, TX (US)

Correspondence Address: NATH & ASSOCIATES, 112 South West Street, Alexandria, VA, 22314, US

(21) Appl. No.: 11/085,139

(22) Filed: Mar. 22, 2005

(51) Int. Cl. G09G 5/00

(52) U.S. Cl. 345/173

(57) ABSTRACT

The present inventive subject matter relates to a multi-panel writing surface and visual display device. More particularly, the present inventive subject matter relates to a multi-panel writing surface and visual display device with each panel having an erasable surface, and which may be mounted to a surface to display information. In particular, the present inventive subject matter relates to a multi panel writing surface and visual display device comprising at least one hinge, a front panel having at least one peripheral edge attached to the at least one hinge, a back panel having at least one peripheral edge attached to the at least one hinge; and at least one intermediate panel having at least one peripheral edge attached to the at least one hinge.

### FIELD OF THE INVENTION

The present inventive subject matter relates to a multi-panel writing surface and visual display device. More particularly, the present inventive subject matter relates to a multi-panel writing surface and visual display device with each panel having an erasable surface, and which may be mounted to a surface to display information.

### BACKGROUND OF THE INVENTION

It is well known to display information on surfaces, typically boards on which the information is presented. For example, information is displayed on billboards, signs, prints, posters, chalkboards, and whiteboards, also known as dry erase boards and markerboards. The display may be installed through mounting interfaces to mounting structures such as walls, racks, posts, and stands. However, such known applications are typically characterized either by the relative permanence or the relative impermanence of the surfaces on which the information is contained. For example, the mounting interfaces and associated mounting structures holding or providing the surfaces are generally either too rigid and inflexible or too insubstantial. If the mounting structures are too rigid and inflexible, the mounting surfaces may be immobile and difficult to reconfigure or otherwise to use and store information. On the other hand, if the mounting structure is too insubstantial, the mounting surface maybe highly mobile but otherwise tending to put the information on display at risk of loss before it can be stored. As a result, such known applications are generally not well suited for use in a dynamic work environment, where information is ideally created, displayed (e.g. shared and communicated) and stored in a highly efficient manner.

Another important aspect of displaying information is the amount of information that can be displayed at any given time, and the ease in which this can be done. Many known applications, such as blackboards, whiteboards, tack boards, cork boards, and similar structures only provide a given amount of area for displaying information, which is the same as the size of the display surface, of each structure. In many instances, these devices do not allow a user the requisite surface area to fully and adequately display all necessary information. Because of the lack of necessary surface area needed to fully and accurately portray information, the information may be interpreted incorrectly, or the information has to be continually updated (e.g. by removing and then adding new information). This can be quite burdensome for the user, and for individuals trying to retrieve information from the application.

In an attempt to overcome the shortcomings of known applications, the use of “display boards” has proliferated. Display boards are discrete information-containing structures that are mounted within a workspace or work environment. However, known display boards have typically not provided an amount of surface area needed to adequately present information without the need to continually remove other information. Moreover, many of these applications have continually gotten bigger in size to allow for additional information to be displayed. This though creates another problem in the ability to find the amount of space to properly install and utilize such an application. For example, dry erase boards have gotten increasingly bigger, which forces the buyer and user to allocate a larger amount of space to install the board properly. Many times these dry erase boards can be several feet in length and width. Further, the board's size is proportional to its weight, so the larger the board gets, the more the board weighs. Thus, if a user desires to obtain a larger dry erase board to increase the amount of information that can be displayed, the user will also have to account for the additional space needed to install the board, as well as the correct installation device(s) to ensure the heavier board is properly installed. Therefore, known display boards have not provided a convenient and user-friendly installation process, including a reduced and convenient area size for installation.

Accordingly, it is advantageous to have a display board system adapted to use, display and store information efficiently in a dynamic work environment. It is also advantageous to have a display board system that includes display boards having surface treatments that facilitate the collection, transformation, use, display and storage of information in a variety of formats. It is further advantageous to have a plurality of display panels adapted to support and promote display and storage of a larger amount of information than typically allotted by known applications. It is further advantageous if the mounting structures are configured to allow the efficient use, display and storage of display boards so information contained on the display boards could efficiently be used, displayed, and stored by persons in a work environment to increase productivity, particularly in the performance of groups. Even more advantageous is the ability to increase the amount of information that can be displayed on an application, without having to incur the expense and hassle of accounting for a larger area to install the application.

### SUMMARY OF THE INVENTION

The present inventive subject matter relates to a multi panel writing surface and visual display device comprising at least one hinge, a front panel having at least one peripheral edge attached to the at least one hinge, a back panel having at least one peripheral edge attached to the at least one hinge, and at least one intermediate panel having at least one peripheral edge attached to the at least one hinge.

The present inventive subject matter further relates to a multi panel writing surface and visual display device comprising at least one hinge having at least one knuckle, flange, or combination thereof, a front panel attached to at least one knuckle, flange, or combination thereof of the at least one hinge, a back panel attached to at least one knuckle, flange, or combination thereof of the at least one hinge, and at least one intermediate panel attached to at least one knuckle, flange, or combination thereof of the at least one hinge.

### BRIEF DESCRIPTION OF THE FIGURES

FIG. 1 is an illustration of a front view of an embodiment of an opened multi-panel writing surface and visual display device;

FIG. 2 is another illustration of a front view of an embodiment of an opened multi-panel writing surface and visual display device;

FIG. 3 is a front view of a backside of a front panel and hinge of an embodiment of a multi-panel writing surface and visual display device;

FIG. 4 is an illustration of an elevated top view of a backside of a front panel and hinge of an embodiment of a multi-panel writing surface and visual display device in a closed position;

FIG. 5 is an illustration of a top view of a an embodiment of a multi-panel writing surface and visual display device and hinge in a closed position;

FIG. 6 is an elevated perspective view of an embodiment of a multi-panel writing surface and visual display device in an open position;

FIG. 7 is another elevated top view of an embodiment of a multi-panel writing surface and visual display device in an opened position;

FIG. 8 is an illustration of an exemplary assembly diagram of an embodiment of a multi-panel writing surface and visual display device;

FIG. 9 is an illustration of a top view of another embodiment of a multi-panel writing surface and visual display device and hinge;

FIG. 10 is another illustration of a top view of another embodiment of a multi-panel writing surface and visual display device and hinge;

FIG. 11 is another illustration of a perspective view of another embodiment of a multi-panel writing surface and visual display device and hinge;

FIG. 12 is an illustration of a perspective view of an embodiment of a hinge for a multi-panel writing surface and visual display device;

FIG. 13 is another illustration of a perspective view of the hinge as shown in FIG. 11 of an embodiment of a hinge for a multi-panel writing surface and visual display device;

FIG. 14 is an illustration of a perspective view of another embodiment of a hinge for a multi-panel writing surface and visual display device;

FIG. 15 is an illustration of an assembly diagram of another embodiment of a multi-panel writing surface and visual display device;

FIG. 16 is an illustration of a front view of another embodiment of a multi-panel writing surface and visual display device;

FIG. 17 is an illustration of a top view of an embodiment of a multi-panel writing surface and visual display device as shown in FIG. 16;

FIG. 18 is an illustration of an assembly diagram of an embodiment of a panel for a multi-panel writing surface and visual display device.

### DETAILED DESCRIPTION OF THE INVENTION

The present inventive subject matter relates to a multi-panel writing surface and visual display device. In a particular embodiment, the present inventive subject matter relates to a multi-panel writing surface and visual display device with each panel having an erasable surface, and which may be mounted to a surface to display information.

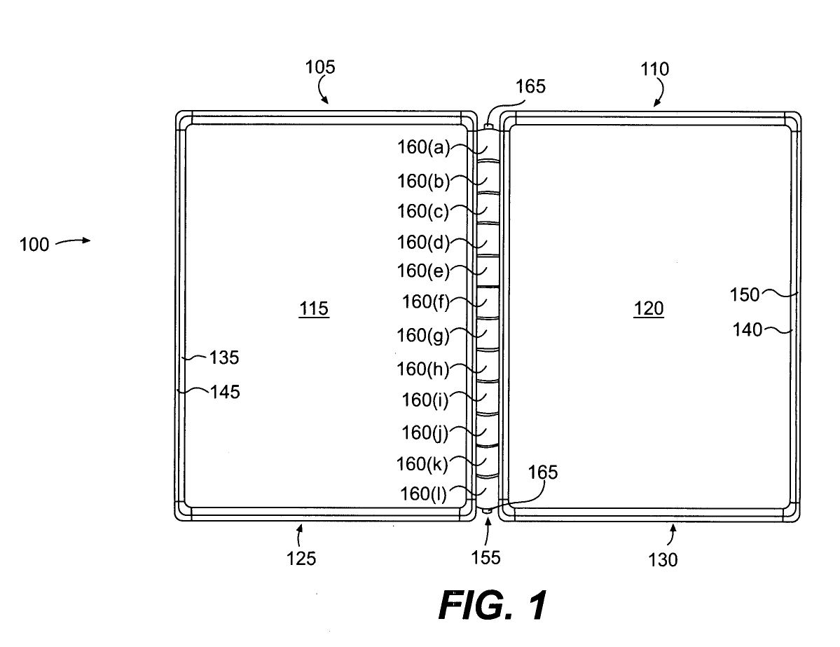

Referring to FIG. 1, an embodiment of an opened multi-panel writing surface and visual display device 100 having a front panel 105 and a back panel 110 is illustrated. Both the front panel 105 and back panel 110 have a writing surface 115 and 120, respectively, as well as a mounting frame 125 and 130 surrounding each writing surface 115 and 120. The front panel mounting frame 125 and back panel mounting frame 130 each have an inner frame 135 and 140 and an outer frame 145 and 150, respectively. Both the front panel 105 and back panel 110 are connected to hinge 155. The hinge 155 comprises a series of knuckles, collectively 160, elongated rod (not shown in this figure), and securing bolts 165. Each knuckle 160(a)-160(l) is attached to either writing surface 115 or writing surface 120. For example, knuckle 160(a) is attached to writing surface 115, while knuckle 160(b) is attached to writing surface 120. Front panel 105 and back panel 110 can be oriented such that each panel is about 0 to about 180 degrees apart. In illustrative FIG. 1, front panel 115 and back panel 120 are oriented about 180 degrees apart.

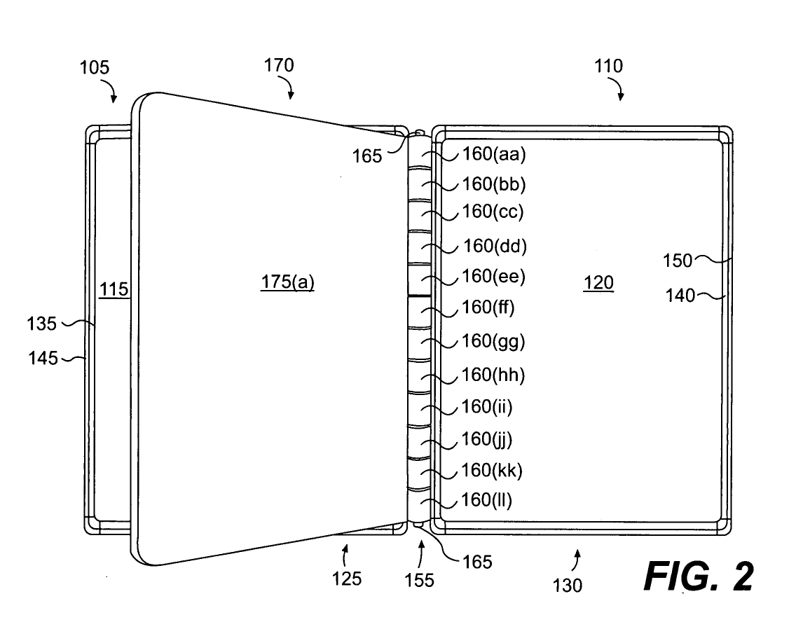

As shown in FIG. 2, a similar embodiment of a multi-panel writing surface and visual display device 100 as shown in FIG. 1. is illustrated; however the device of FIG. 2 has an intermediate panel 170. Intermediate panel 170 has dual writing surfaces 175(a) (only one writing surface is shown in this figure) with each writing surface being on opposite sides of panel 170. As is the same with the embodiment shown in FIG. 1, hinge 155 comprises a series of knuckles, collectively 160, an elongated rod (not shown in this figure), and securing bolts 165. In the embodiment of FIG. 2, knuckles 160(bb), 160(ff), and 160(jj) are attached to intermediate panel 170, and allow intermediate panel 170 to attach to hinge 155.

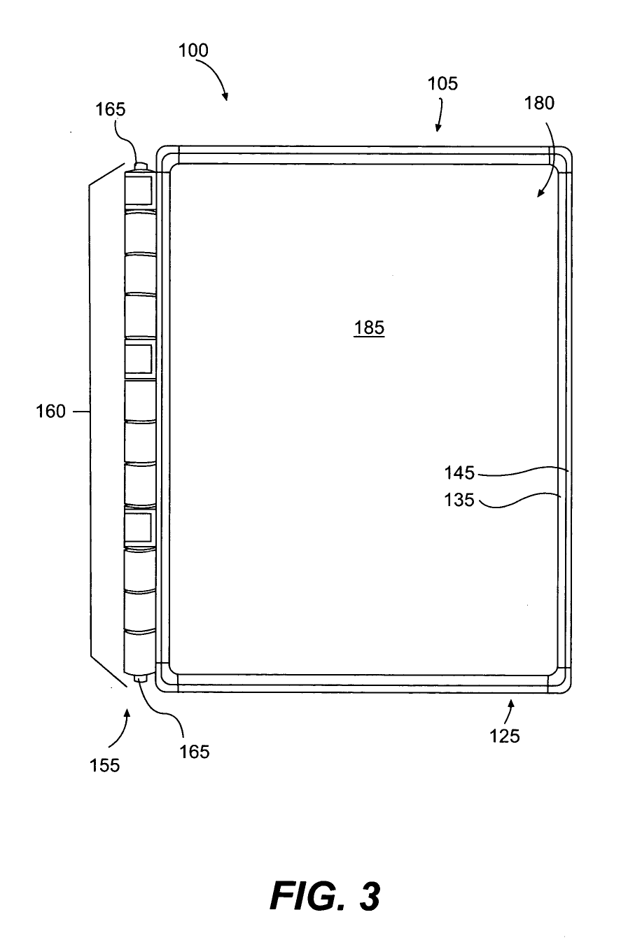

Referring to FIG. 3, another similar embodiment of a multi-panel writing surface and visual display device 100 as shown in FIG. 1 is illustrated. However, the device of FIG. 3 shows a multi-panel writing surface and visual display device 100 having a front panel 105, which has back side 180. In this particular embodiment, the back side 180 of front panel 105 has a mounting frame 125 surrounding backing surface 185. Backing surface 185 can be constructed out of any suitable material, and can also serve as a tack board.

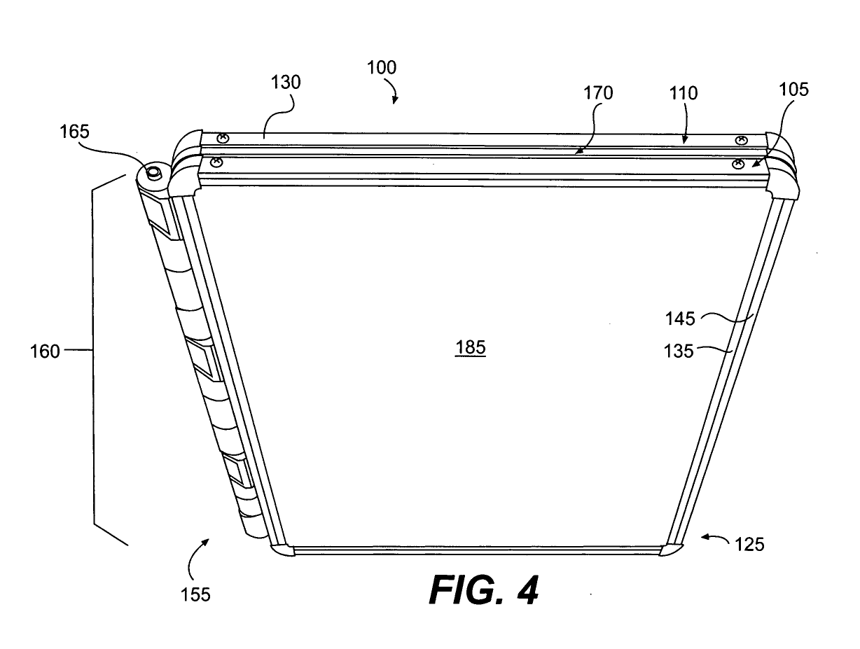

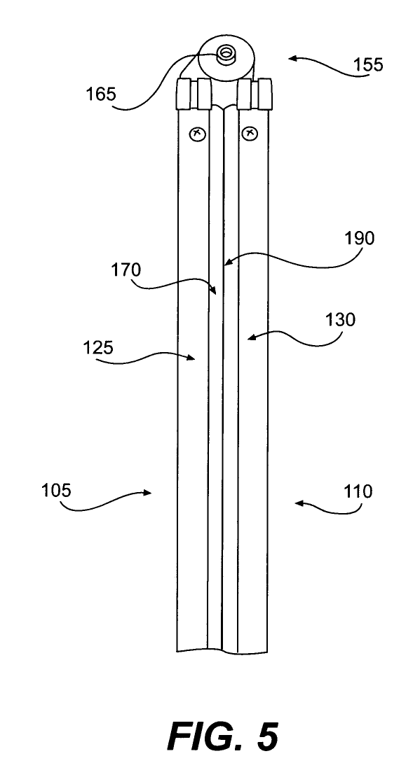

Referring now to FIGS. 4 and 5, an exemplary embodiment of a multi-panel writing surface and visual display device 100 having a front panel 105 and back panel 110, both having mounting frames 125 and 130, respectively, surrounding each panel is illustrated. Both front and back panels 105 and 110, respectively, are connected to hinge 155, and intermediate panel 170 resides between the front and back panels (105 and 110) and is connected to hinge 155 as well. Hinge 155 comprises knuckles 160, collectively, as well as elongated rod (not shown) and securing bolts 165. FIG. 5 shows another embodiment of a multi panel writing surface and visual display device 100 in which an additional intermediate panel 190 is between intermediate panel 170 and back panel 110. Intermediate panel 190 also has dual writing surfaces (not shown in this figure) with each writing surface being on opposite sides of panel 190. Further, intermediate panel 190 is attached to knuckles 160 (not shown in FIG. 5), which attaches intermediate panel 190 to hinge 155.

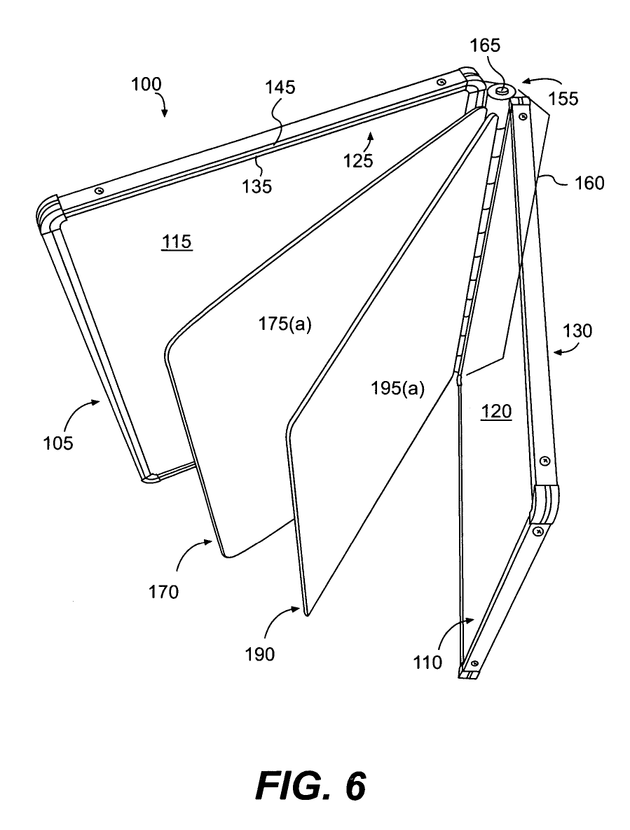

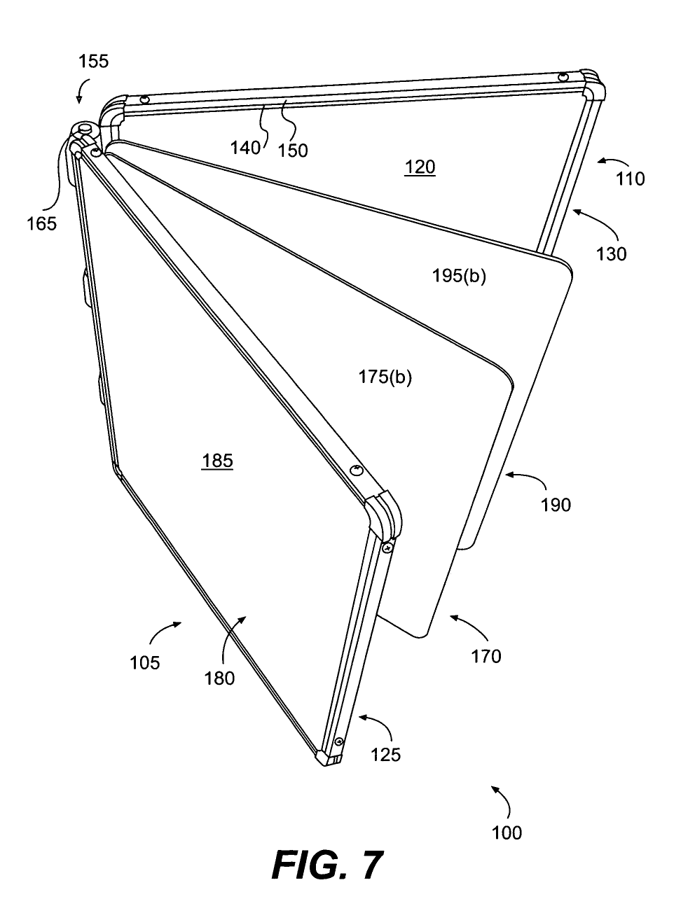

As shown in FIGS. 6 and 7, another exemplary embodiment of a multi panel writing surface and visual display device 100 is illustrated. Front panel 105 and back panel 110 both have writing surfaces 115 (not shown in FIG. 7) and 120, respectively. Further, both the front and back panels 105, 110 have mounting frames 125, 130, with both mounting frames 125, 130 having both an inner frames 135, 140 and outer frames 145, 150, respectively. Both the front panel 105 and back panel 110 are attached to knuckles 160 (not shown in FIG. 7), which attach both panels 105, 110 to hinge 155. Additionally, intermediate panels 170 and 190 are both located between front panel 105 and back panel 110. Intermediate panel 170 has two writing surfaces on opposing sides 175(a) (not shown in FIG. 7) and 175(b) (not shown in FIG. 6), and intermediate panel 190 has two writing surfaces on opposing sides 195(a) (not shown in FIG. 7) and 195(b) (not shown in FIG. 6).

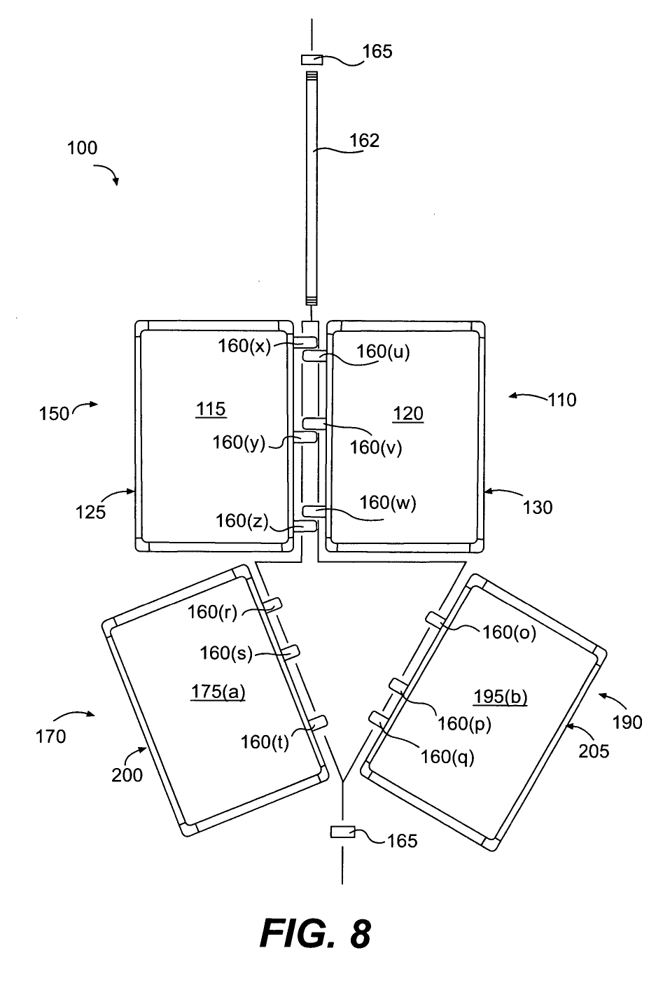

Referring now to FIG. 8, an exemplary assembly diagram for an embodiment of a multi-panel writing surface and visual display device 100 having a front panel 105, back panel 110, and two intermediate panels 170, 190 is illustrated. Front panel 105, back panel 110, intermediate panel 170, and intermediate panel 190 are aligned such that knuckles 160 attached to each panel are organized in a substantially straight path so that elongated rod 162 can pass through a hole in the center portion of each knuckle. For example, knuckles 160(x), 160(y), and 160(z) form a first set of knuckles, and are attached to front panel 105. Knuckles 160(u), 160(v), and 160(w) form a second set of knuckles, and are attached to back panel 110. Knuckles 160(r), 160(s), and 160(t) form a third set of knuckles, and are attached to intermediate panel 170. Knuckles 160(o), 160(p), and 160(q) form a fourth set of knuckles, and are attached to intermediate panel 190. The knuckles are then aligned in an exemplary order of 160(x), 160(u), 160(r), 160(o), 160(s), 160(v), 160(y), 160(p), 160(t), 160(q), 160(w), and 160(z), thus aligning front panel 105, back panel 110, and intermediate panels 170 and 190. This exemplary alignment produces an exemplary embodiment of a multi-panel writing surface and visual display device 100, where intermediate panel 190 precedes back panel 110, intermediate panel 170 precedes intermediate panel 190, and front panel 105 precedes intermediate panel 170. Elongated rod 162 is passed through each hole of each knuckle 160(o)-160(z) with securing bolts 165 being attached to the ends of the elongated rod 162 to secure the elongated rod 162 in each hole of each knuckle 160(o)-160(z). The exemplary embodiment of a multi-panel writing surface and visual display device 100 in FIG. 8 additionally shows intermediate panels 170 and 190 having mounting frames 200 and 205, respectively. Mounting frames 200 and 205 can be a multi-frame construction, such as previously shown for mounting frames 125 and 130, or a single frame construction.

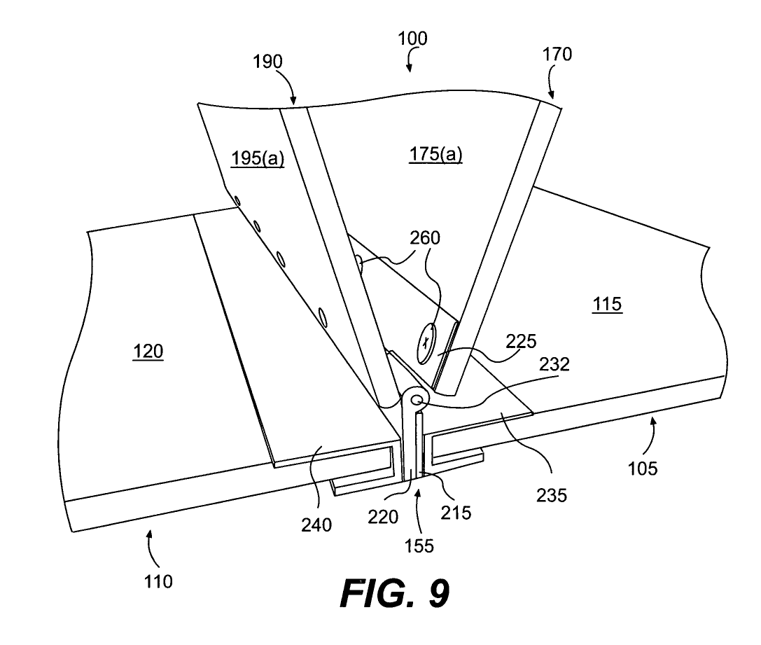

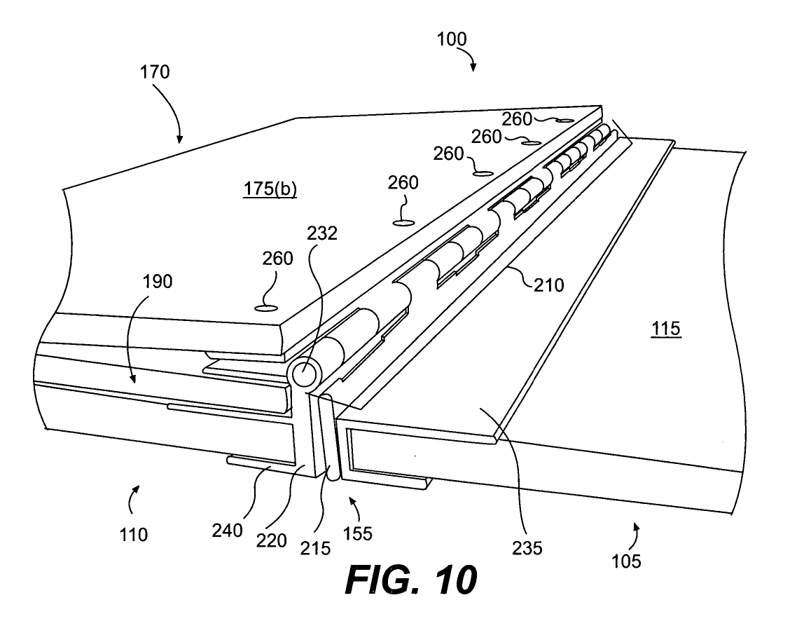

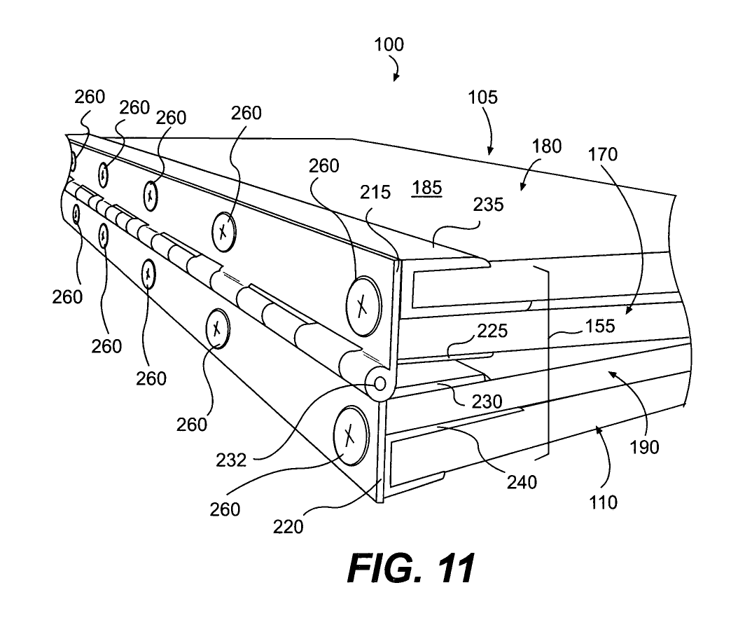

As shown in FIGS. 9, 10, and 11, other embodiments of multi-panel writing surface and visual display devices 100 are illustrated. In these embodiments, front panel 105, back panel 110, intermediate panel 170, and intermediate panel 190 are all attached to hinge 155. In these exemplary embodiments, hinge 155 comprises a series of less prominent knuckles 210 (not shown in FIG. 9) attached to flanges 215, 220, 225, and 230 (not shown). Knuckles 210 are organized in a substantially straight path so that elongated rod 232 can pass through a hole in the center portion of each knuckle. Flange 215 attaches to c-channel 235 in which writing surface 115 resides. Flange 220 attaches to c-channel 240 in which writing surface 120 resides. Flange 225 and flange 230 (not shown) are attached to intermediate panel 170 and intermediate panel 190, respectively. C-channels 235 and 240 are attached to flanges 215 and 220 respectively by a securing device 260. In these embodiments, hinge 155 comprises knuckles 210, elongated rod 232, flanges 215, 220, 225, and 230, and securing device 260. Securing device 260 can be items such as, but not limited to, at least one screw, nail, clamp, bolt, or similar mechanical device separately, or in combination. Further, securing device 260 can be a chemical substance such as, but not limited to, at least one adhesive, bonding agent, or combination thereof. Additionally, intermediate panels 170 and 190 are attached to flanges 225 and 230 respectively by securing device 260. Intermediate panels 170 and 190 are not situated within c-channels and attached to flanges 225 and 230, however, such an arrangement is well within the scope of this disclosure. If such an embodiment is desired, flanges 215 and 220 can be radially elongated (i.e. width extended), so that when the multi panel writing surface and visual display device 100 is closed, such as in FIG. 11, the length from the outer edge of flange 215 to the outer edge of flange 220 is greater than if intermediate panels 170 and 190 are not situated within c-channels.

Additionally, as shown in FIG. 11, an embodiment of a multi-panel writing surface and visual display device 100 has a back side 180 of front panel 105 having a backing surface 185, which is the same as writing surfaces 115, 120, 175(a), 175(b), 195(a), and 195(b) of previously disclosed embodiments. Thus, in this embodiment, the backing surface 185 of front panel 105 may serve not as a tack board surface, but as an additional writing surface.

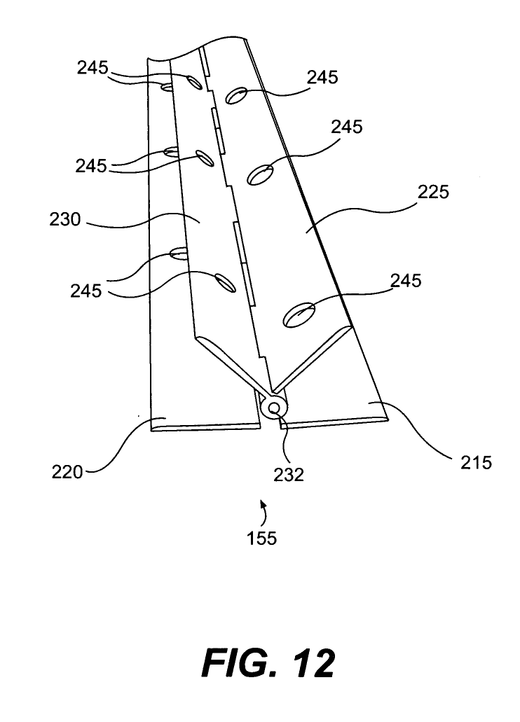

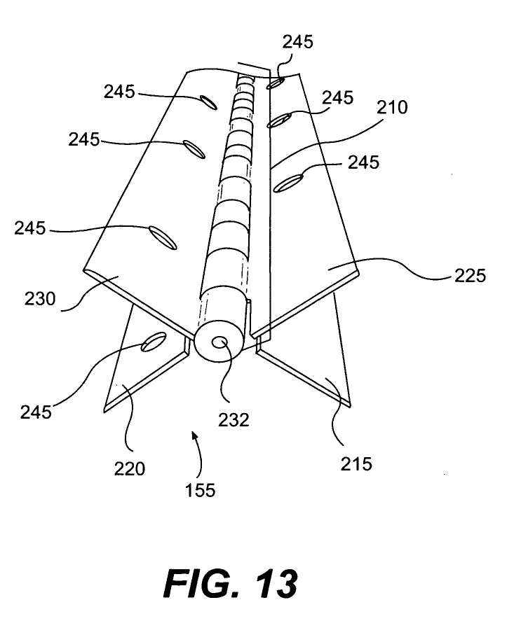

Referring now to FIGS. 12 and 13, an embodiment of a flanged hinge 155, such as that used for a multi panel writing surface and visual display device 100 of FIGS. 9, 10, and 11 is illustrated. The hinge 155 has flanges 215, 220, 225, and 230, as well as openings 245 along the length of the flanges 215, 220, 225, and 230. The openings 245 are to allow securing device 260 to attach each flange 215, 220, 225, and 230 to either a c-channel, such as c-channel 235 or 240, or to a panel, such as front panel 105, back panel 110, or an intermediate panel, such as intermediate panels 170 and 190. Openings 245 on each flange are optional.

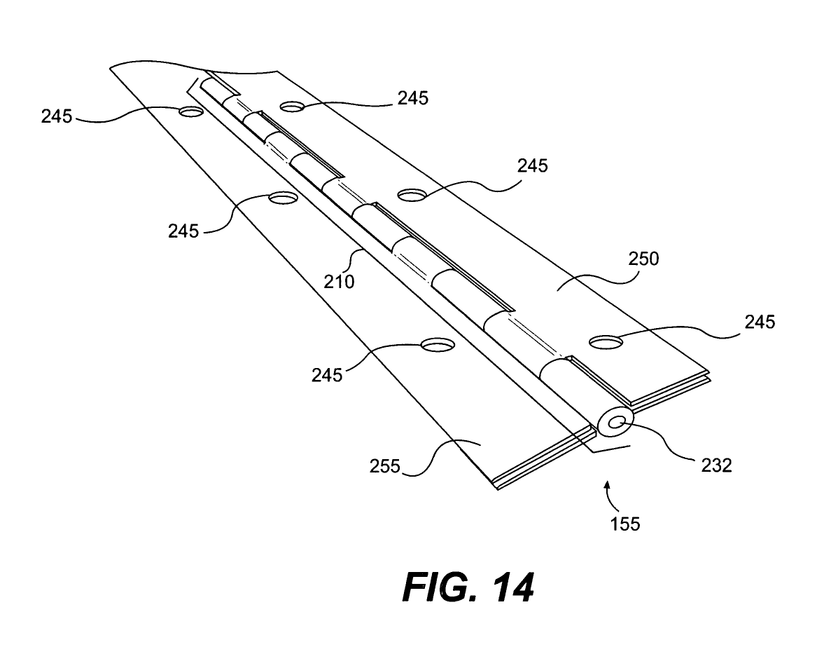

As shown in FIG. 14, another embodiment of a hinge 155 is illustrated. In this embodiment, hinge 155 has two flanges 250 and 255. As previously shown in other exemplary embodiments, flanges 250 and 255 have openings 245 located along the length of the flanges 250 and 255 to allow a securing device 260 to attach each flange 250 and 255 to either a c-channel, such as c-channel 235 or 240, or to a panel, such as front panel 105, back panel 110, or an intermediate panel, such as intermediate panels 170 and 190.

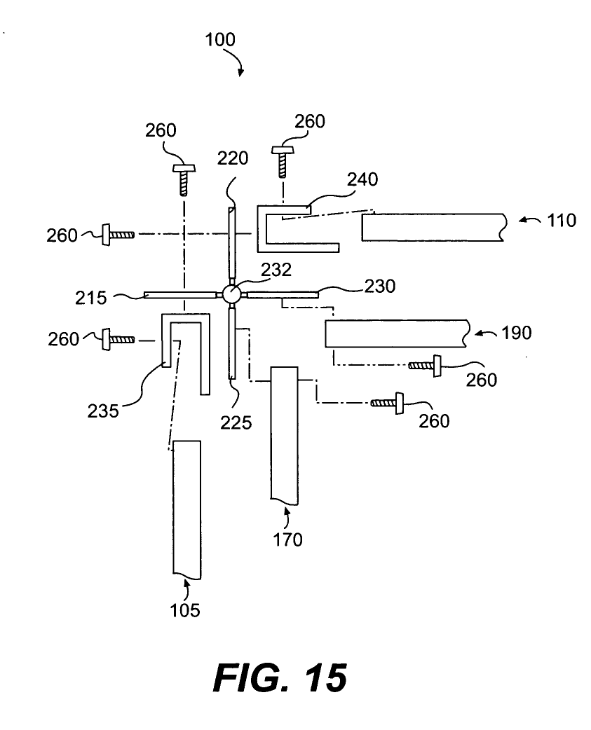

Referring now to FIG. 15, another exemplary assembly diagram for a multi-panel writing surface and visual display device 100 having a front panel 105, back panel 110, and two intermediate panels 170, 190 is illustrated. Front panel 105 is connected to flange 215 through c-channel 235 by securing device 260. Securing device 260 can be as previously defined above. Back panel 110 is connected to flange 220 through c-channel 240 by securing device 260. Intermediate panels 170 and 190 are connected to flanges 225 and 230 by securing devices 260. Flanges 215, 220, 225, and 230 are connected to elongated rod 232 by knuckles 210, and can rotate around the elongated rod 232. In this particular embodiment, flanges 215, 220, 225, and 230 have a free range of motion around elongated rod 232. In other words, each flange can rotate about 360 degrees around elongated rod 232. As a non-limiting example, if flange 220 is positioned such that it rests flush against flange 215, flange 220 can rotate from against flange 215 around elongated rod 232 until resting flush against flange 230. The range of motion is 360 degrees minus the height of flanges 215, 225, and 230.

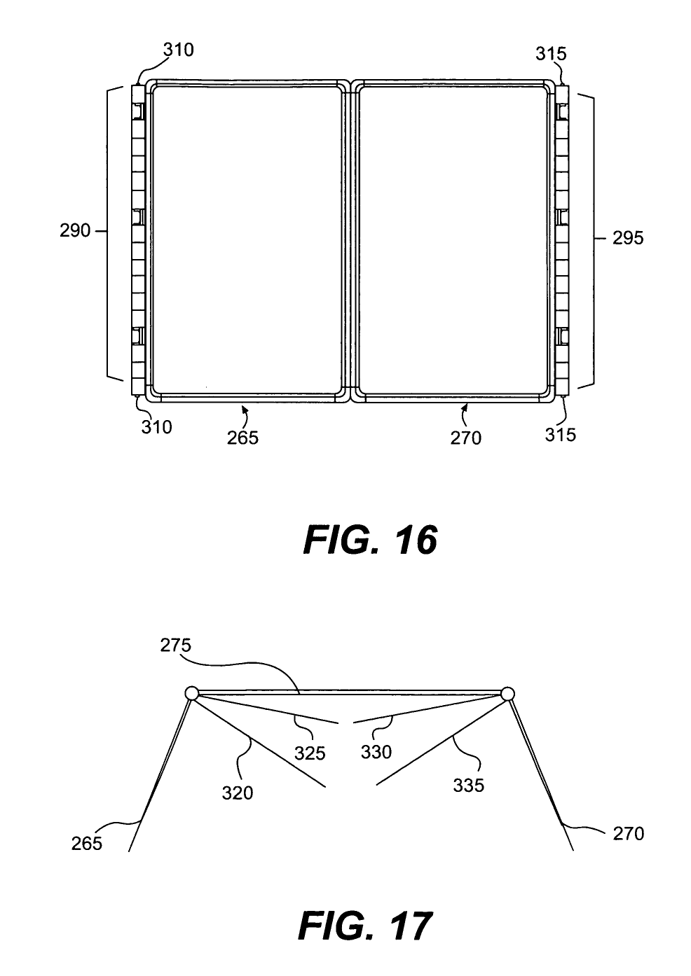

As shown in FIGS. 16 and 17, another exemplary embodiment of a multi-panel writing surface and visual display device 100 is illustrated. In this embodiment, there are two front panels 265 and 270 attached to back panel 275 by hinges 280 and 285. Hinges 280 and 285 comprise a series of knuckles 290 and 295, respectively, elongated rods (both not shown in this figure), and securing bolts 310 and 315. Between front panels 265 and panel 270 and back panel 275 are intermediate panels 320, 325, 330, and 335. The front panels 265 and 270, as well as intermediate panels 320, 325, 330, and 335 can be oriented such that each panel is about 180 degrees apart from back panel 275. Additionally, each panel can be oriented such that each panel is about 0 to about 180 degrees apart from back panel 275.

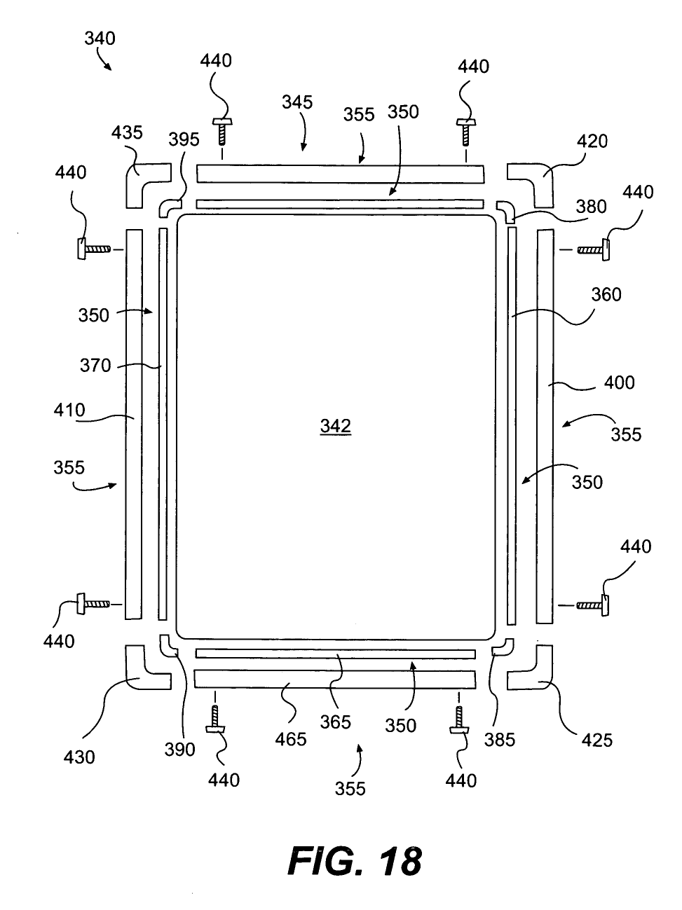

Referring now to FIG. 18, an exemplary assembly diagram for a panel 340 for a multi-panel writing surface and visual display device 100 is illustrated. Panel 340 can be a front, back, or intermediate panel construction. Panel 340 comprises a writing surface 342 and mounting frame 345, which has an inner frame 350 and an outer frame 355. Inner frame 350 has rails 360, 365, 370, and 375 with corners 380, 385, 390, and 395 situated in between each rail. Corners 380, 385, 390, and 395 are attached to rails 360, 365, 370, and 375 to form inner frame 350. Outer frame 355 has rails 400, 405, 410, and 415 with corners 420, 425, 430, and 435 situated in between each rail. Corners 420, 425, 430, and 435 are attached to rails 400, 405, 410, and 415 to form outer frame 355. Inner frame 350 is connected to outer frame 355 to form mounting frame 345 by securing devices 440. Writing surface 342 can be constructed from any suitable material, including but not limited to, any metal, alloy, plastic, polymer, elastomer, wood, fiberglass, porcelain, and combinations thereof. Writing 342 provides a surface in which information can be displayed and removed. Non-limiting examples of applications that can be used as a writing surface include, dry erase board surfaces, also known as white board and marker board surfaces, black board surfaces, polymer surfaces, elastomer surfaces, glass surfaces, porcelain surfaces, and combinations thereof. In one non-limiting example, writing surfaces of a multi panel writing surface and visual display device are dry erase board applications. Rails 360, 365, 370, 375, 400, 405, 410, and 415 can be constructed from any suitable material, including but not limited to, any metal, alloy, plastic, polymer, elastomer, wood, fiberglass, porcelain, and combinations thereof. Rails 360, 365, 370, 375, 400, 405, 410, and 415 provide a peripheral edge to panels in which they are attached and can help aid in preventing the warping and bubbling of panels. Corners 380, 385, 390, 395, 420, 425, 430, and 435 can be constructed from any suitable material, including but not limited to, any metal, alloy, plastic, polymer, elastomer, wood, fiberglass, porcelain, and combinations thereof. Corners 380, 385, 390, 395, 420, 425, 430, and 435 provide interconnections between rails 360, 365, 370, 375, 400, 405, 410, and 415, and can help reduce damage done to panels when panels are rotated around a hinge by dampening some or all of the force created when panels are struck against one another.

The above embodiments are merely exemplary embodiments of the present inventive subject matter, and should not be seen as limiting the scope of the disclosure provided herein.

The multi-panel writing surface and visual display device of the present inventive subject matter can have two or more panels attached to a hinge.

The panels of the present inventive subject matter can be of single or multi device construction, and can be constructed of any suitable material, including, but not limited to any metal, alloy, plastic, polymer, elastomer, wood, fiberglass, porcelain, particleboard, fiberboard, and combinations thereof. As a non-limiting example, a panel can comprise a substrate constructed of an inflexible material, such as particleboard or fiberboard, and have a laminated surface attached on opposite face sides of the board. Additionally, as a non-limiting example, a panel can comprise a substrate constructed of an inflexible material, such as particleboard or fiberboard, and have a magnetic metal sheet disposed between the substrate and a laminated surface attached on opposite face sides of the board. Further, as a non-limiting example, a panel can substantially comprise a flexible or non-flexible polymeric material, such as but not limited to, a thermoplastic, a thermosetting, an acrylate, an acrylic, an amide, a carbonate, a chlorinated polymer, a copolymer, an ester, an ether, a fluorinated polymer, a ketone, a methacrylate, an olefin, a rubber, a styrenic, a sulfur containing polymer, a vinyl, polyvinyl chloride, elastomeric olefins, styrenic butadiene, acetate film, polystyrene, and polyethylene, and derivatives and combinations thereof.

The panels of the present invention can be rigid or flexible. As a non-limiting example, rigid panels of the present invention can be of any dry erase board, chalkboard, or blackboard construction. Further, as a non-limiting example, flexible panels of the present invention can be of film or paper-like constructions.

Moreover, panels of the present inventive subject matter can be pivotable around at least one substantially linear axis. Further, panels can have knuckles directly attached or indirectly attached thereto. As a non-limiting example of panels of the present inventive subject matter, panels can be formed such that knuckles form an integral part of the panel. Such panels can be constructed of, but not limited to, a polymer material from processes such as, but not limited to, injection molding with knuckles forming an integral part of the panel. As another non-limiting example of panels of the present inventive subject matter, panels can be constructed such that knuckles are attached to the panel by a mechanical device or chemical interaction, such as attaching flanges to a panel, where the flanges are attached to the knuckles, which comprise a hinge.

Further, panels of the present inventive subject matter can have a frame or edge around at least the peripheral edge. The frame or edge can be constructed of any suitable material, including, but not limited to any metal, alloy, plastic, polymer, elastomer, wood, fiberglass, porcelain, particleboard, fiberboard, and combinations thereof. The frame or edge can have a single or multi-device construction, and can be attached to the peripheral edge and any surrounding area of the panels by at least one mechanical device or chemical substance. As a non-limiting example, the frame or edge can be constructed from a plastic, polymer, elastomer, and combinations thereof and band the peripheral edge of the panels. Non-limiting examples of a mechanical device that can secure a frame or edge to a panel include, but are not limited to, a bolt, a screw, a crimp, a clamp, a nail, and combinations thereof. Non-limiting examples of chemical substances that can secure a frame or edge to a panel include, but are not limited to an adhesive, a bonding agent, and combinations thereof. As previously described above, frames can comprise rails and corners. Rails and corners can be constructed from any suitable material, including but not limited to, any metal, alloy, plastic, polymer, elastomer, wood, fiberglass, porcelain, particleboard, fiberboard, and combinations thereof.

In particular embodiments of the present inventive subject matter, at least one panel will have a writing surface that is erasable. Erasable surfaces include, but are not limited to, dry erase board surfaces, also known as white board and marker board surfaces, blackboard surfaces, polymer surfaces, elastomer surfaces, glass surfaces, porcelain surfaces, and combinations thereof. Accordingly, the erasable surface can be constructed from any suitable material, including but not limited to any metal, alloy, plastic, polymer, elastomer, wood, fiberglass, glass, porcelain, and combinations thereof. Non-limiting examples of a flexible or non-flexible polymeric material include a thermoplastic, a thermosetting, an acrylate, an acrylic, an amide, a carbonate, a chlorinated polymer, a copolymer, an ester, an ether, a fluorinated polymer, a ketone, a methacrylate, an olefin, a rubber, a styrenic, a sulfur containing polymer, a vinyl, polyvinyl chloride, elastomeric olefins, styrenic butadiene, acetate film, polystyrene, and polyethylene, and derivatives and combinations thereof.

Further, in a particular embodiment, the panels can be constructed from a fiberboard or particleboard substrate having a laminate sheet attached to both face sides of the board, with a frame around the peripheral edge of the board. The frame can be of a single or multi device construction, and can have corners. Additionally, in a particular embodiment, the panels can be constructed from a fiberboard or particleboard substrate having a metal sheet disposed between the substrate and a laminate sheet, where the metal and laminate sheets are attached to both face sides of the board, with a frame around the peripheral edge of the board. In another embodiment, the panels of a multi panel writing surface and visual display device can be constructed such that the panels are completely constructed of a writing surface.

Hinges of the present inventive subject matter can comprise any number of elements, including, but not limited to, at least one knuckle, elongated rod, flange, and securing device. In a further embodiment, the hinge will comprise at least one knuckle, elongated rod, and securing device. In another embodiment, the hinge will comprise incorporating at least part of an edge of a panel for attachment purposes. As a non-limiting example, if panels are constructed of a flexible polymer material, the hinge can comprise at least a part of the peripheral edge of each panel, which is secured in a substantially linear fashion such that at least part of the peripheral edge of each panel intersectingly attaches along one axis. Further, the hinge may not comprise knuckles, and may be a substantially linear intersection of panels. As a non-limiting example, an embodiment of a multi-panel writing surface and visual display device can have flexible polymeric sheets interconnected along a peripheral edge of each sheet, such that the hinge comprises the peripheral edge of each sheet and the physical end product or area of the securing device or attachment process interconnecting each sheet.

The hinges of the present inventive subject matter can be of single or multi-device construction, and can be constructed of any suitable material, including, but not limited to any metal, alloy, plastic, polymer, elastomer, wood, fiberglass, porcelain, particleboard, fiberboard, and combinations thereof. The purpose of the hinge is to interconnect each panel such that at least one portion of each panel is attached to the hinge, and for the hinge to allow at least a substantially free range of motion from about 0 to about 180 degrees for each panel.

Non-limiting examples of polymers which can be used in the present inventive subject matter include, but are not limited to thermoplastic polymers, thermoset polymers, an acrylate containing polymer, an acrylic containing polymer, an amide containing polymer, a carbonate containing polymer, a chlorinated polymer, a copolymer, an ester containing polymer, an ether containing polymer, a fluorinated polymer, a ketone containing polymer, a methacrylate containing polymer, an olefin containing polymer, a rubber, a styrenic containing polymer, a sulfur containing polymer, a vinyl containing polymer, polyvinyl chloride containing polymer, elastomeric olefins, styrenic butadiene, acetate film, polystyrene, polyethylene, latex, polyvinyl chloride, silicone, polyvinyl alcohol, chlorinated polyethylene resins, ethylene vinyl alcohol, fluoroplastics, ionomers, polyacrylates, polybutadiene, polybutylene, polyethylene, polyethylenechlorinates, polymethylpentene, polypropylene, polystyrene, polyvinylchloride, polyurethane, polybutylene, high-molecular-weight polyethersulfone, polyphenylsulfone, polyvinylidene, fluoride polyamide-imide, PVDF homopolymer, PVDF copolymer, PVDF homopolymer, ECTFE copolymer, ECTFE nBuA terpolymer, polyarylamide, liquid crystal polymer, acrylonitrile-butadiene-styrene, aramid, bakelit, diene polymer, dimethylformamid, epoxy, polyvinyl chloride, hydroxy-terminated polybutadiene (HTPB), teflon, nylon 6, nylon 6,6, polycarbonate, polyester, silicones, nylon, PA (Polyamid), PE (Polyethylen), phenol-formaldehyde, polyacrylates, polyacrylonitrile, polybutadiene, polyetherimide, polygermane, polystannane, polyisoprene, polymethyl methacrylate, polyoxymethylene, polyoxymethylene copolymer, polyoxymethylene homopolymer, poly(para-xylylene), polyphosphazenes, polypropylen, polysilanes, polystyrene, polystyrol, polytetrafluoroethylen, polyurethan, synthetic polyisoprene, vinyl, polyvinylidene chloride, polyamide, polyamide-imide, polyaryletherketone, polycarbonate, polyketone, polyester, polyetheretherketone, polyetherimide, polyethersulfone, polyimide, polyphenylene oxide, polyphenylene sulfide, polyphthalamide, polysulfone, chlorinated polyethylene resin, allyl resin, melamine formaldehyde, phenol-formaldehyde plastic, silicone, polyurethane, epoxy, cellulosic, acrylonitrile-butadiene-styrene, liquid crystal polymer, polyacetal, polyacrylonitrile, thermoplastic elastomers, diisodecyl phthalate, and combinations, mixtures, and derivatives thereof.

Non-limiting examples of wood material which can be used in the present inventive subject matter include compositions with cellulosic fiber including particleboard, fiberboard, plywood, and combinations and derivatives thereof. Non-limiting examples of glass material which can be used in the present inventive subject matter include fiberglass, porcelain, tempered glass, and combinations, mixtures, and derivatives thereof. Non-limiting examples of metals and alloys which can be used in the present inventive subject matter include iron, steel, aluminum, tin, copper, bronze, and combinations, mixtures, and derivatives thereof.

Generally, embodiments of a multi panel writing surface and visual display device will comprise at least three panels and a hinge. The panels can be of singular or multi component construction and can be flexible or rigid. Generally, the panels will have at least one writing surface attached or incorporated therein, and will be attached to a hinge or connected in such a fashion to form a hinge structure.

Embodiments of the multi panel writing surface and visual display device as discussed herein can be mounted to a display surface, such as a wall, by a mounting system. Mounting system can comprise at least one bracket, clip, clamp, securing device, and combinations thereof. As a non-limiting example, the multi panel writing surface and visual display device can be mounted to a display surface by using at least one bracket secured to the peripheral edge of the bottom and top of the back panel, with both brackets further secured to the display surface. In another non-limiting example, the multi panel writing surface and visual display device can be mounted to a display surface by constructing a back panel of the multi panel writing surface and visual display device to have hanging holes therein, such that at least one securing device can be mounted into the display surface and the visual display device mounted thereon. Non-limiting examples of a mechanical securing device includes at least one bolt, screw, crimp, clamp, nail, and combinations thereof. Non-limiting examples of chemical securing device includes at least one adhesive, a bonding agent, and combinations and mixtures thereof.

The present invention has been described with respect to preferred selected embodiments, and several alternative embodiments thereof. However, other embodiments would be obvious to those skilled in the art without departing from the spirit and scope of the appended claims.

We claim:

1) A multi panel writing surface and visual display device comprising:
at least one hinge;
a front panel having at least one peripheral edge attached to said at least one hinge;
a back panel having at least one peripheral edge attached to said at least one hinge; and
at least one intermediate panel having at least one peripheral edge attached to said at least one hinge.

2) The multi-panel writing surface and visual display device of claim 1, wherein said front panel, said back panel, and said at least one intermediate panel each comprise at least one writing surface.

3) The multi-panel writing surface and visual display device of claim 2, wherein said at least one writing surface is selected from the group consisting of a dry erase board surface, a blackboard surface, and a paper surface.

4) The multi-panel writing surface and visual display device of claim 2, wherein said at least one writing surface is magnetic.

5) The multi-panel writing surface and visual display device of claim 1, wherein said front panel and said back panel further comprise at least one frame.

6) The multi-panel writing surface of claim 5, wherein said at least one frame comprises at least one material selected from the group consisting of aluminum, steel, iron, graphite, and combinations thereof.

7) The multi-panel writing surface and visual display device of claim 5, wherein said at least one frame comprises at least one material selected from the group consisting of a polymer and an elastomer.

8) The multi-panel writing surface and visual display device of claim 1, wherein said intermediate panel further comprises at least one frame.

9) The multi-panel writing surface and visual display device of claim 1, wherein at least said front panel further includes a tack surface.

10) The multi-panel writing surface and visual display device of claim 1, wherein said front panel, said back panel, and said at least one intermediate panel each further comprise at least one knuckle.

11) The multi-panel writing surface and visual display device of claim 10, wherein said at least one knuckle is included in said peripheral edge of each said front panel, said back panel, and said at least one intermediate panel.

12) The multi-panel writing surface and visual display device of claim 10, wherein said knuckle has an opening there through substantially parallel to said writing surface of each said front panel, said back panel, and said at least one intermediate panel.

13) A multi panel writing surface and visual display device comprising:
at least one hinge having at least one knuckle, flange, or combination thereof;
a front panel attached to at least one said knuckle, flange, or combination thereof of said at least one hinge;
a back panel attached to at least one said knuckle, flange, or combination thereof of said at least one hinge; and
at least one intermediate panel attached to at least one said knuckle, flange, or combination thereof of said at least one hinge.

14) The multi-panel writing surface and visual display device of claim 13, wherein said hinge comprises an elongated rod.

15) The multi-panel writing surface and visual display device of claim 14, wherein said elongated rod passes through a hole in a knuckle of a panel.

16) The multi-panel writing surface and visual display device of claim 14, wherein said hinge comprises at least one securing bolt connected to an end of said elongated rod.

17) A multi-panel writing surface and visual display device comprising a hinge having at least three flanges or at least three separate sets of knuckles in which said at least three flanges or at least three separate set of knuckles each connect to a separate panel and allow each said panel at least about 180 degrees of motion around a substantially linear axis.

18) The multi-panel writing surface and visual display device of claim 17, wherein said substantially linear axis is defined by an elongated rod.

19) The multi-panel writing surface and visual display device of claim 17, wherein each said at least three flanges or each said at least three separate sets of knuckles are each integrated into a separate panel such that each said at least three flanges or each said at least three separate sets of knuckles and each said separate panel form a single, integrated entity.

20) The multi-panel writing surface and visual display device of claim 17, wherein each said at least three flanges or each said at least three separate sets of knuckles are connected to a separate panel such that each said at least three flanges or each said at least three separate sets of knuckles and each said separate panel form a single, connected entity.
